(19) United States
(12) Patent Application Publication
(10) Pub. No.: US 2007/0136520 A1
(43) Pub. Date: Jun. 14, 2007

(54) Device for and method of recording digital information signals

(75) Inventors: Gerrit Jan Scholl, Eindhoven (NL); Johannis Friso Rendert Blacquiere, Eindhoven (NL); Pope Ijtsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/579,304

(22) PCT Filed: Nov. 16, 2004
(86) PCT No.: PCT/IB04/52435

§ 371 Date: May 16, 2006

(30) Foreign Application Priority Data
Nov. 21, 2003 (EP) 03104313.6

(51) Int. Cl. G06F 12/00

(52) U.S. Cl. 711/112

(57) ABSTRACT

A recording apparatus for recording digital information signals on a removable rewritable disc like recording medium has been proposed. The apparatus comprises writing means (21, 22, 25) for recording the digital information signals and control means (20) for controlling the recording. The apparatus is capable of storing first file system data and second file system data addressing user data in a user area (UA) on the medium. The control means (20) are adapted to store only one set of file entries shared by both file systems data. This reduces time and space necessary for handling file system data.

The invention relates to a device for recording digital information signals in addressable locations on a removable rewritable disc like recording medium, the digital information signals representing user data, first file system data and second file system data, each file system data comprising a corresponding set of file entries, the file entries comprising address references pointing to the user data according to a predefined format and defined relative to a reference point, the device comprising

recording means for recording the digital information signals on the medium;

reading means for reading recorded digital information signals recorded on the medium;

control means for controlling recording the digital information signals.

The invention further relates to a method of recording digital information signals in addressable locations on a removable disc like recording medium, the digital information signals representing user data, first file system data and second file system data, each file system data comprising a corresponding set of file entries, the file entries comprising address references pointing to the user data according to a predefined format and defined relative to a reference point.

The invention also relates to a computer data system comprising a computer connected to a device for recording digital information signals in addressable locations on a removable rewritable disc like recording medium, the digital information signals representing user data, first file system data and second file system data, each file system data comprising a corresponding set of file entries, the file entries comprising address references pointing to the user data according to a predefined format and defined relative to a reference point, the device comprising

input means connected to the computer for receiving the digital information signals;

recording means for recording the digital information signals on the medium;

reading means for reading recorded digital information signals recorded on the medium;

output means for outputting the read digital information signals to the computer;

control means for controlling recording the digital information signals.

The invention further relates to a computer program product for recording digital information signals in addressable locations on a removable rewritable disc like recording medium.

Recording media like optical discs (DVD+RW, Blu-ray Disc, etc.) are capable of storing large amount of data of different types. They can be used in different environments having specific requirements as for organization of data on a recording medium. Typically, data are organized into files in accordance with rules of a particular file system. Such file system has its own file system data, which include information about all kind of structures relating to data stored on a recording medium. In particular, file system data may include volume structures representing the structures of logical and/or physical volumes, file entries representing the structures of files containing the data, directory entries describing grouping of files, and a space bitmap representing allocated and/or unallocated space for storing data on a recording medium. A recording medium may comprise addressable recording units for storing the data. At a level of a file system those units are referenced to with use of logical addresses defining addressing (storage) space to be used for storing sequences of information blocks, such as files under control (according to rules) of the file system, for example UDF. Partitioning of the recording medium allocates this space on the medium.

At present, for example, DVD+RW discs are in use by Consumer Electronics (CE) devices and in the Personal Computer (PC) environment. In the CE environment DVD+RW discs are used mainly for recording digital video information according to a format of DVD Video Recording, commonly referred to as DVD+VR. This means that there are defined specific allocation rules and set of files containing the video information itself and information about that video information such as title information, menu structures, etc. Next to that the (predefined) list of files has to be physically on a medium in a certain order.

The PC environment is based on a different philosophy. There are, in principle, no specific allocation requirements. Specific applications may require some files to be present in a certain directory and applications will typically have their own data format to store information in files or to retrieve information from a file. This means that as long as there is free space available on a medium it is possible to add data files to that medium from all kinds of different applications. As an example, on a single disc there could be multi-media files, text files and executable files all mixed with each other.

Recently, more and more CE devices, like video players/recorders, have capability to seek through the file system information on the disc for files of a certain type that they can handle as well. Example of this are (mainly) JPEG files and also, already more and more, MP3 files. In the future possibly more types of multi-media files will be supported in the CE world. Next to that, also new standards on meta-data are created (such as e.g. MPV or HighMAT) designed to make it easier to move digital content between PCs and home electronics devices, e.g. by providing a common “look and feel” in different environments.

The published international patent application WO 01/22416 A1 discloses the device capable of performing initialization, formatting and defect management of a rewritable medium such as a CD-RW disc. This is done to facilitate the use of CD-RW as a high-capacity floppy disc, so immediate recording or reading of files is possible. Such media are commonly referred to as Mount Rainier ReWritable (MRW) media, e.g. CD-MRW, DVD+MRW.

The device has recording means for recording the information in information blocks having logical addresses on an optical disc in a track at allocated physical addresses. The logical addresses constitute a contiguous storage space. In practice, the record carrier may exhibit defective parts of the track, in particular a defect preventing a block to be recorded at a specific physical address. These defects might be caused by scratches, dust, fingerprints and so on. Initially, before any user data is recorded, defects are detected, and physical addresses of defective sectors are removed from use in a defect table, a process usually called slipping. In the event of defects detected during use of the record carrier, logical addresses assigned to defective physical addresses are assigned to different physical addresses in a defect management area called also a spare area, a process usually called remapping or linear replacement.

Further, said device makes it possible to store file system data of different file systems on one recording medium, so-called “bridge medium”. This facilitates sharing of the bridge medium between different environments, e.g. the CE environment and the PC environment. A special part of a recording medium, called a general application area (GAA), is allocated for storing e.g. file system data of a file system used by other devices. In case of DVD+MRW media, GAA has a size of 2 MBytes.

In the PC environment the most likely way of adding data to the bridge medium is by means of “drag-and-drop” technique. A user can then make the medium compatible with legacy players through the use of a compliance (bridge) application running on the PC. Basically, the application writes second file system data, called “CE-bridge”, to the medium, using the suitable file system(s) and content pointers, such that a legacy “non-MRW” system can interpret these as content under its main file system. As a result, the CE-player will play the content that is referenced by this file system data, for which it has suitable content decoders.

Creation or modification of the CE-bridge requires searching through the first file system data and copying file/directory entries to the CE-bridge. Moreover, it requires modifying all file/directory entries that are copied to the CE-bridge. This is so because address references stored inside file/directory entries are defined relative to the start of a partition of a file system. In addition, formats of address references used by both file systems might be different. Searching for, copying and modifying file/directory entries is a time consuming process.

Therefore, it is an object of the invention to provide more economic way of sharing the bridge medium between different environments.

This object is achieved, according to a first aspect of the invention, by a device for recording digital information signals of the type described in the opening paragraph, characterized in that

the control means are adapted to perform a verification in order to check whether the first file system address references format is the same as the second file system address references format and whether the first file system reference point is the same as the second file system reference point, and to record only one set of the file entries shared by both file systems data in case of positive result of the verification. This reduces time and space necessary for handling the CE-bridge.

In an embodiment of the device for recording digital information signals, the control means are adapted to perform the verification comprising checking whether both file systems data share one file set descriptor, and to record only one set of the directory entries shared by both file systems data in case of positive result of the verification. This embodiment is advantageous in that it further decreases time and space necessary for handling the CE-bridge.

In a further embodiment of the device for recording digital information signals, the control means are adapted to perform the verification comprising comparing versions of both file systems. This can be used to check formats of address references used by both file systems.

In another embodiment of the device for recording digital information signals, the control means are adapted to check a bit flag comprising information related to both file system address references formats and both file system reference points. This is advantageous in that it provides simple and quick way of verifying whether file entries can be shared by both file systems.

In another embodiment of the device for recording digital information signals, the control means are adapted to check a bit flag comprising information related to the one file set descriptor. This is advantageous in that it provides simple and quick way of verifying whether directory entries can be shared by two file systems.

It is advantageous, if the control means are adapted to read the bit flag from the medium. This is useful in case of modification of the CE-bridge, which was created by another device or after re-inserting the medium to the device.

A further embodiment of the device for recording digital information signals is characterized in that the control means are adapted to perform an initialization comprising defining file system partitions for recording the user data such that the first file system partition and the second file system partition start at the same point being the first file system reference point and the second file system reference point. This allows for creation of the bridge medium with file entries shared by two file systems.

In another embodiment of the device for recording digital information signals, the control means are adapted to record the first file system volume descriptor and the second file system volume descriptor, both pointing to the one file set descriptor shared by both file systems data. This allows for creation of the bridge medium with not only file entries shared by two file systems but also directory entries. Only basic information of the CE-bridge needs to be recorded on the medium; file and directory entries recorded under control of the first file system are automatically shared by two file systems.

For the medium comprising a spare area outside the user area comprising replacement areas for the defect management it is advantageous, if the control means are adapted to define the second file partition comprising the spare area This allows the user data remapped to the spare area to be addressed from within the second file system partition.

Advantageously, the control means are adapted to perform the initialization comprising setting-up the bit flag. This bit flag can be used by the verification following the initialization

It is advantageous, if the control means are adapted to record the bit flag on the medium. This is useful in case of modifications of the CE-bridge performed after removing and re-inserting the medium to the device.

According to a second aspect of the invention a method of recording digital information signals of the type described in the opening paragraph is provided, characterized by:
a verification step in order to check whether the first file system address references format is the same as the second file system address references format and whether the first file system reference point is the same as the second file system reference point;
recording only one set of the file entries shared by both file systems data in case of positive result of the verification step.

According to a third aspect of the invention a computer data system of the type described in the opening paragraph is provided, characterized in that the computer is adapted to control the control means of the device for recording digital information signals to perform the method as described in relation to the second aspect of the invention.

According to a fourth aspect of the invention a computer program product for recording digital information signals recorded on a removable rewritable disc like recording medium is provided, which program is operative to cause a processor to perform the method as described in relation to the second aspect of the invention.

These and other aspects of the invention will be apparent from and elucidated further with reference to the embodiments described by way of example in the following description and with reference to the accompanying drawings, in which:

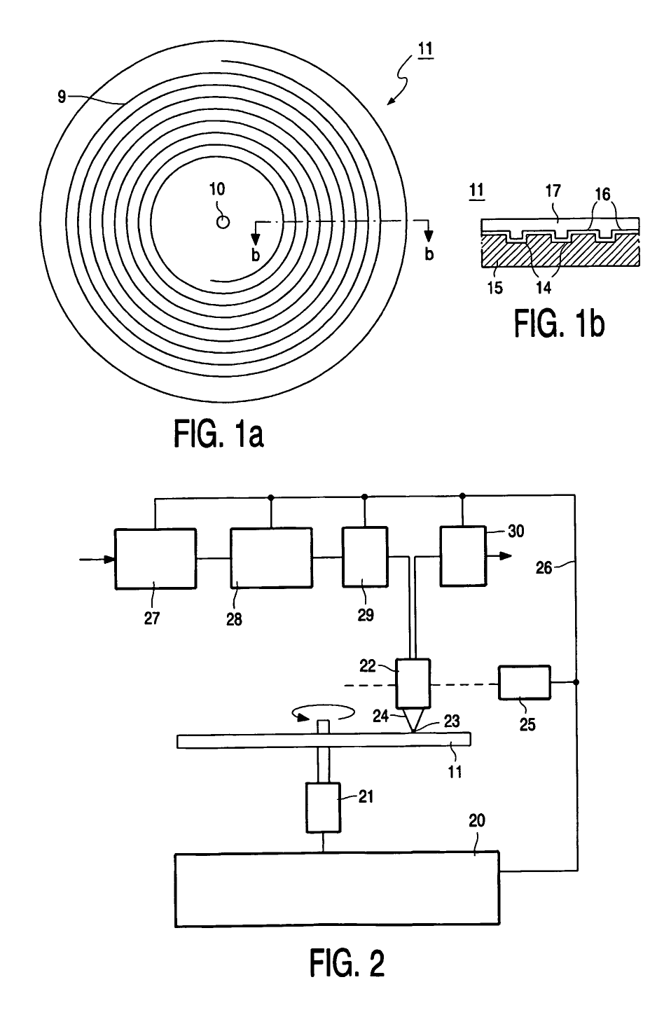

FIG. 1a shows a recording medium (top view),

FIG. 1b shows a recording medium (cross section),

FIG. 2 shows a device for recording digital information signals, in accordance with the invention,

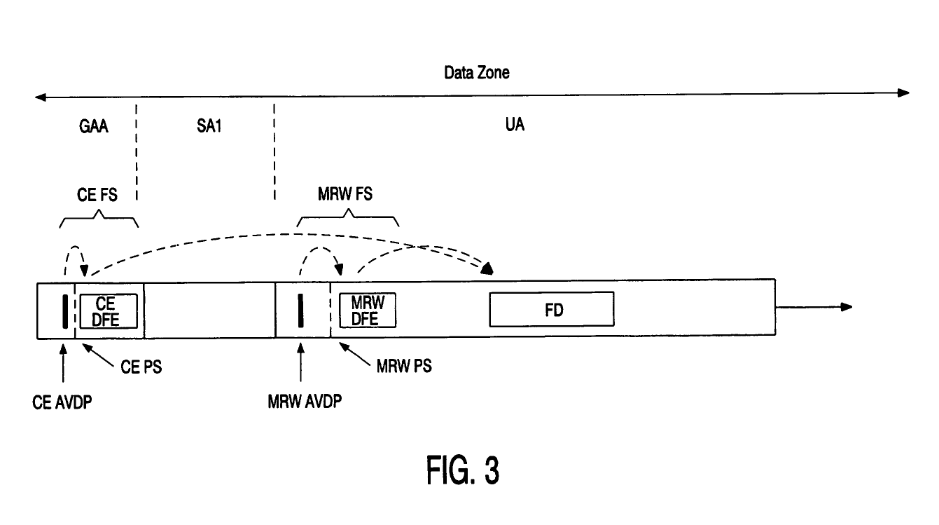

FIG. 3 shows a simplified layout of a MRW type of medium,

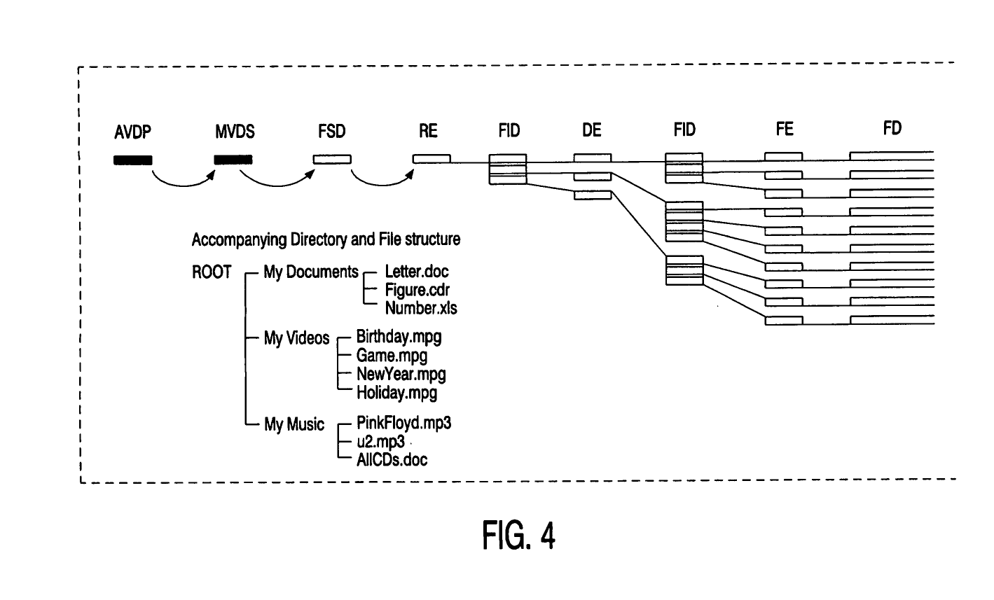

FIG. 4 shows a simplified structure of a UDF file system,

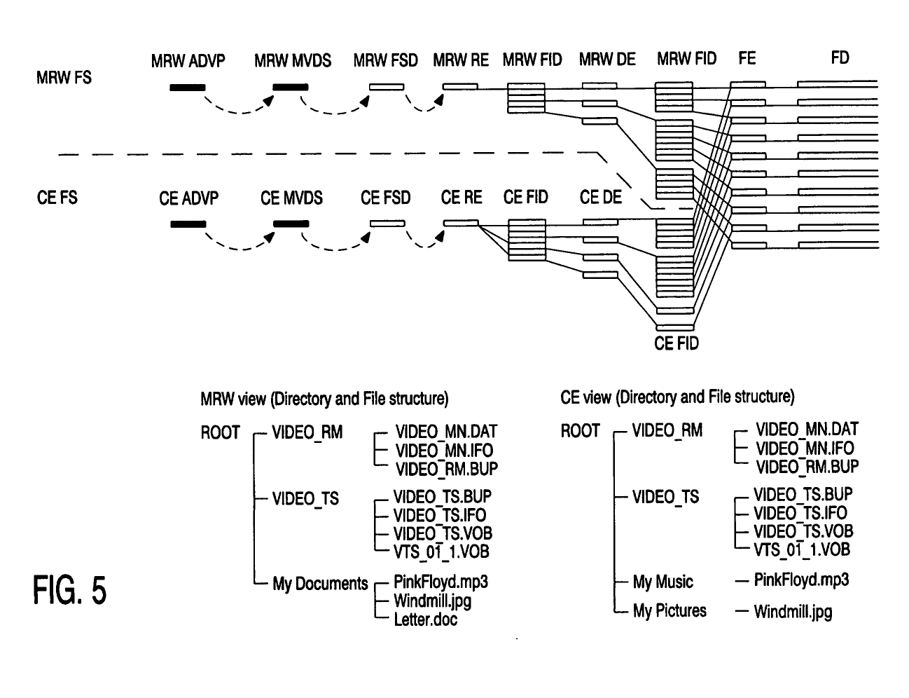

FIG. 5 shows schematically MRW and CE file system structures sharing File Entries, in accordance with the invention.

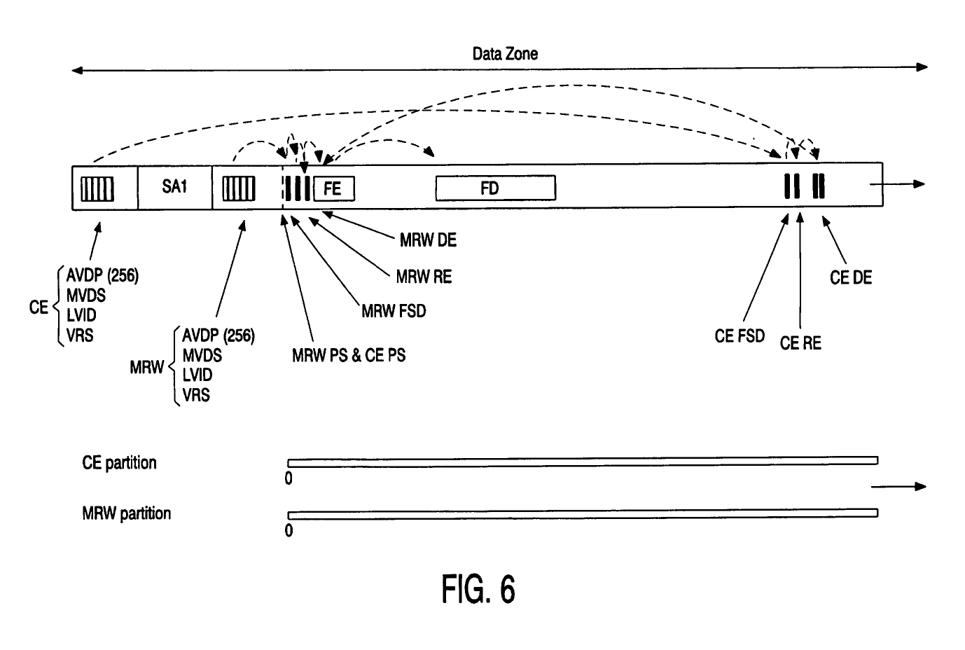

FIG. 6 shows an example of a simplified structure of the DVD+MRW bridge medium with shared File Entries, in accordance with the invention.

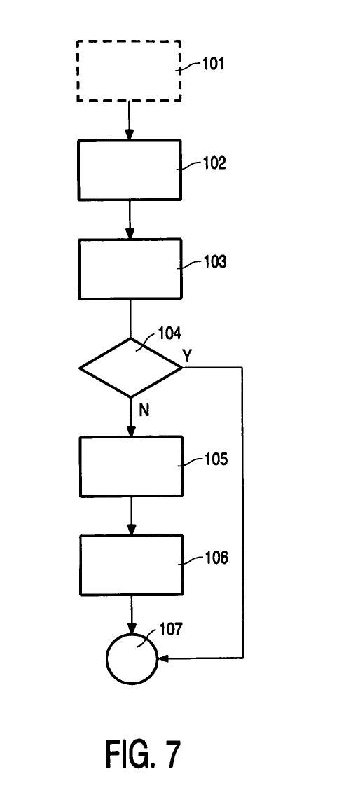

FIG. 7 shows an example of a method of recording digital information signals, in accordance with the invention.

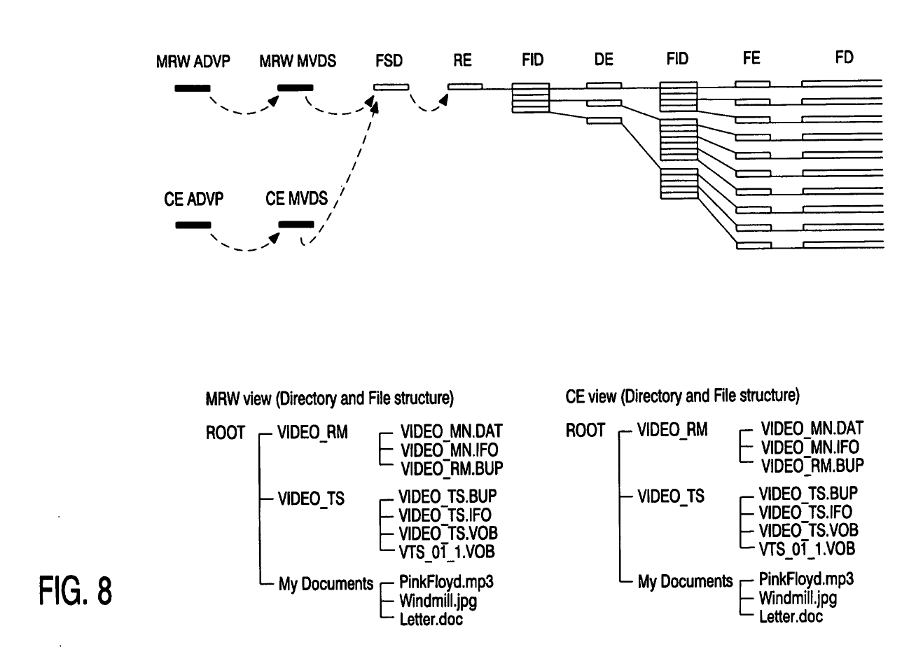

FIG. 8 shows schematically MRW and CE file system structures sharing File and Directory Entries, in accordance with the invention.

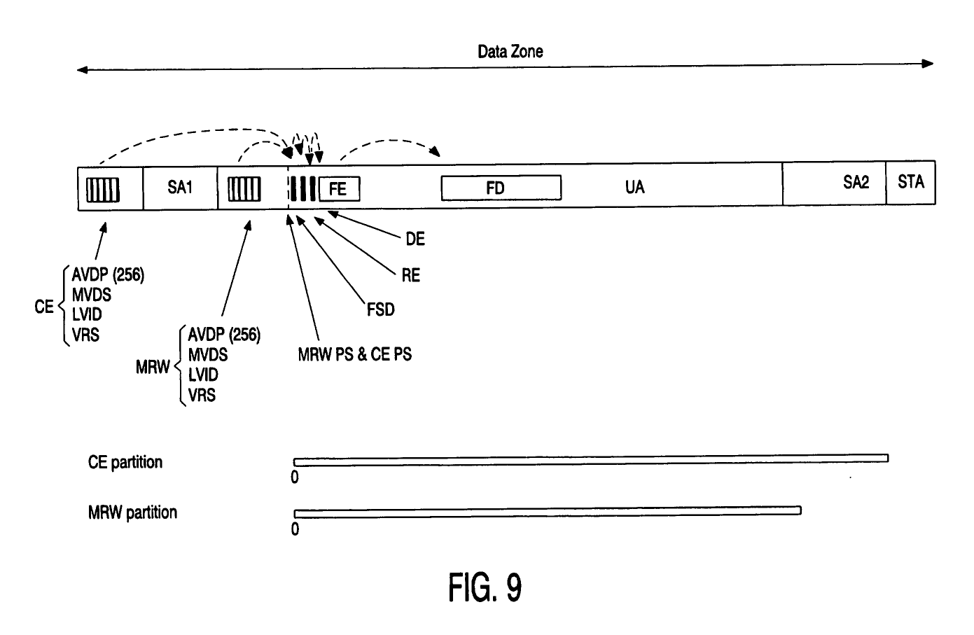

FIG. 9 shows an example of a simplified structure of the DVD+MRW bridge medium with shared File and Directory Entries, in accordance with the invention.

Corresponding elements in different Figures have identical reference numerals and symbols.

FIG. 1a shows an example of a recording medium 11 having a form of disc with a track 9 and a central hole 10. The track 9, being the position of the series of (to be) recorded marks representing digital information signals (data), is arranged in accordance with a spiral pattern of turns constituting substantially parallel tracks on an information layer. The recording medium may be optically readable, called an optical disc, and has an information layer of a recordable type. Examples of a recordable disc are the CD-RW, and writable versions of DVD, such as DVD+RW, and the high-density writable optical disc using blue lasers, called Blu-ray Disc (BD). Digital information signals (data) are represented on the information layer by recording optically detectable marks along the track, e.g. crystalline or amorphous marks in phase change material. The track 9 on the recordable type of recording medium is indicated by a pre-embossed track structure provided during manufacture of the blank recording medium. The track structure is constituted, for example, by a pregroove 14, which enables a read/write head to follow the track during scanning. The track structure comprises position information, e.g. addresses, for indication the location of units of information, usually called information blocks or packets.

FIG. 1b is a cross-section taken along the line b-b of the recording medium 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

FIG. 2 shows a device for recording digital information signals a recording medium 11 such as CD-RW, DVD+RW or BD, in accordance with the invention. The device is provided with recording means for scanning the track on the recording medium, which means include a drive unit 21 for rotating the recording medium 11, a head 22, and a positioning unit 25 for coarsely positioning the head 22 in the radial direction on the track. The head 22 comprises an optical system of a known type for generating a radiation beam 24 guided through optical elements focused to a radiation spot 23 on a track of the information layer of the recording medium. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For recording digital information signals (data) the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading, the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the digital information signals (data). Hence retrieving means for reading information include the drive unit 21, the head 22, the positioning unit 25 and the read processing unit 30. The device comprises write processing means for processing input data to generate a write signal to drive the head 22, which means comprise an input unit 27, and modulator means comprising a formatter 28 and a modulator 29. The input data may comprise for example real-time video and/or audio data, still images data or other user data. The input unit 27 processes the input data to units of information, which are passed to the formatter 28 for adding control data and formatting the data, e.g. by adding error correction codes (ECC) and/or interleaving. The formatted data from the output of the formatter 28 is passed to the modulation unit 29, which comprises for example a channel coder, for generating a modulated signal, which drives the head 22. Further the modulation unit 29 comprises synchronizing means for including synchronizing patterns in the modulated signal. The formatted units presented to the input of the modulation unit 29 comprise address information and are written to corresponding addressable locations on the recording medium under the control of a control unit 20. The control unit 20 controls the recording and retrieving of information and may be arranged for receiving commands from a user or from a host computer. The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits.

In an embodiment the device is a storage system only, e.g. an optical disc drive for use in a computer. The control unit 20 is arranged to communicate with a processing unit in the host computer via a standardized interface (not shown). Digital data (comprising the user data and/or file system(s) data) is interfaced to the formatter 28 and from the read processing unit 30 directly. In this case, the interface acts as the input unit and an output unit; as an option, the input unit 27 does not have to be present in the device.

In an embodiment the device is arranged as a stand alone unit, for example a video recording apparatus for consumer use. The control unit 20, or an additional host control unit included in the device, is arranged to be controlled directly by the user, and to perform the functions of the file system(s), e.g. generating file system data. The device includes application data processing, e.g. audio and/or video processing circuits. User information is presented on the input unit 27, which may comprise compression means for input signals such as analog audio and/or video, or digital uncompressed audio/video. The read processing unit 30 may comprise suitable audio and/or video decoding units.

The control unit 20 is capable of controlling recording of file system data of different file systems on one recording medium, so-called “bridge medium”. This facilitates sharing of the bridge medium between different environments, e.g. the CE environment and the PC environment as explained in the introductory part.

FIG. 3 shows an example of the bridge medium, in this case simplified layout of the medium commonly referred to as Mount Rainier ReWritable (MRW) medium, DVD+MRW. It comprises, among other areas, a general application area GAA, a spare area SA (in this example comprising two sub-areas SA1 and SA2) and a user area UA. The user area UA is used mainly for recording of data used for real use and data related to content stored on a recording medium, such as user data organized in file data FD and first (main) file system data, MRW FS, comprising directory and file entries, MRW DFE, pointing to the user data according to rules of a first file system. The general application area GAA can be used for storage of data that does not allow replacements by a defect management, such as application programs, remappers for assuring that non-MRW systems can perform address remapping in order to logically construct the address space (compensating for the defect management reallocation not interpretable by non-MRW drives), device drivers that can handle defects, or file system data of additional file systems. The spare area SA is used by the defect management. In case of DVD+MRW recording media, GAA, SA1 and SA2 have a size of 2, 8 and 120 (or 504) MBytes, respectively. MRW PS and CE PS indicate a start (beginning) of the MRW file system partition and the CE file system partition, respectively.

Based on the MRW definitions, it is possible to ensure that MRW media can be read by non-MRW capable drives, by installing a remapping driver on the PC. This remapping driver can be obtained easily, amongst other, by using GAA, such that the file system in GAA launches an application, which installs this driver or downloads it from the Internet. For convergence with non-MRW aware CE devices, a file system of the same or a different type (typically ISO9660 or UDF) can be used for allowing addressing of the content typically recognized by CE devices. This is done by pointing to the multimedia content stored in UA of the MRW medium, using file system data stored in GAA, hereinafter also referred to as second file system data, CE FS, with its own directory and file entries, CE DFE.

In an embodiment, the control unit 20 functions as so-called “bridge application”. File and directory entries of one file system are mirrored in equivalents of other data structure belonging to other file system. During this process, information about changes in file systems data is gathered and then all or only selected file/directory entries are mirrored. This selection is done using a pre-defined set of file types, file systems characteristics or other conditions. After addition (modification) of the data on the bridge medium, file systems data must be synchronized by the bridge application. Depending whether the medium is used in a “knowledgeable” environment, i.e. the environment wherein it can be assured that two file systems data are kept synchronized, or in an “unknowledgeable” environment (where the two file systems data can not be kept synchronized), the medium may have correct or incorrect CE bridge information, respectively. Therefore special actions of a special convergence bridge application able to restore the CE bridge, have to be performed. This could be a part of the functionality of the “knowledgeable” environment, to assure the medium always leaves this environment with the correct CE bridge.

In an advantageous embodiment of the device, the control unit 20 is adapted to block write access to the whole user area or its part for devices not capable of updating the CE-bridge. For example, the control unit 20 can be adapted to set directories/files to read-only. This can be done selectively per file or per directory, e.g. only the content the video player can playback like the video_merge_ts directories are set to read-only.

FIG. 4 shows a simplified structure of a UDF file system representing the directory and file structure on a recording medium. The Anchor Volume Descriptor Pointer AVDP points toward the Main Volume Descriptor Sequence MVDS, which comprises the Logical Volume Descriptor LVD, the Partition Descriptor PD, the Primary Volume Descriptor PVD, the Implementation Use Volume Descriptor IUVD and the Unallocated Space Descriptor USD. LVD contains information about the logical volume. It points toward the File Set Descriptor FSD. Partitions map logical space to physical space. Normally, this is a linear mapping where an offset (location) and a length is specified by PD. PVD contains some information about the physical volume, whereas IUVD contains implementation specific information about the volume. Information about free space on the volume is comprised in USD. AVDP is located at the logical block having the logical address 256. For example, for MRW FS on a DVD+MRW medium, this logical address corresponds to the 5376ₜₕ physical block after the lead-in (in case there is no remapping applied). The UDF file system structure comprises also the Volume Recognition Sequence VRS at the logical address 16. AVDP, MVDS and VRS are located outside the partition. FSD identifies a set of files and directories and contains a pointer to so-called ROOT Entry RE that describes the ROOT directory. The directory and file tree that gives a user an overview of the contents on the medium, starts at the ROOT directory and is created via Directory and File Entries, DE and FE respectively, that are all linked to each other via pointers as shown schematically by arrows in FIG. 4. Also shown in FIG. 4 are the File Identifier Descriptors (FID); they can be seen as the data of a directory and they contain pointers to files and directories in that particular directory. RE, FID, DE and FE together form the file and directory structure of the UDF file system. They, as well as FSD, are located inside the partition. Each file entry contains address references (links) pointing to data belonging to a corresponding file. The address references have a format specific for a given file system and are defined relative to a reference point, which in case of UDF is a beginning of the partition. The ROOT Entry, Directory Entries and File Entries of the UDF file system have the same data format defined by the UDF specification and use the same reference point; they are often called simply file entries. Generally, the MRW file system address references format can be different from the CE file system address references format. Also, MRW and CE address references can be defined relative to different reference points, for example when MRW and CE partitions start at different points as shown in FIG. 3.

The control unit 20 is adapted to perform a verification in order to check whether the first file system address references format is the same as the second file system address references format and whether the first file system reference point is the same as the second file system reference point, and to record only one set of the file entries shared by both file systems data in case of positive result of the verification. This verification can be performed when the file entries are created, modified or added to file systems data on the bridge medium. In one embodiment the verification is executed automatically by the control unit 20. In another embodiment, the control unit 20 performs the verification in response to a request from a user. This request can be initiated by e.g. pressing a “make convergence” button. In advantageous embodiment, the control unit 20 is adapted to perform the verification right after the medium is mounted by the device. The device according to the invention is capable (after positive verification) of recording only one copy of the file entries, common for MRW and CE file systems. It is not necessary to record two sets of file entries. This is shown schematically in FIG. 5. The file entries FE forming one, common set are pointed to by directory entries corresponding to different file systems data, MRW DE and CE DE. FIG. 6 shows an example of a simplified structure of the DVD+MRW bridge medium with shared file entries FE.

A particular method performed by the control unit 20 of an embodiment of the device is shown in FIG. 7. In a step GENERATE1 102, the first file system file entries are generated. Next, in a step RECORD1 103, those file entries are recorded on the medium. The verification is performed in a step VERIFY 104. If the verification gives a positive result the procedure is terminated in a step END 107, as no recording of the second file system file entries is necessary. Otherwise, the second file system file entries are generated in a step GENERATE2 105 and then recorded on the medium, in a step RECORD2 106. The step VERIFY 104 can also be executed before the step RECORD1 103 or the step GENERATE1 102; in such case the positive result of the verification terminates the procedure after the step RECORD1 103.

In an embodiment of the device, the control unit 20 is adapted to perform the verification comprising checking whether both file systems data share one file set descriptor FSD, and to record only one set of the directory entries shared by both file systems data in case of positive result of the verification. It is not necessary to record two sets of directory entries. This is shown schematically in FIG. 8. The file entries FE, the directory entries DE and the ROOT entry RE form one, common structure (tree) shared by MRW FS and CE FS. FIG. 9 shows an example of a simplified structure of the DVD+MRW bridge medium with shared file entries FE and directory entries DE. Both file systems have the same view of the user data on the medium.

In an embodiment of the method according to the invention, the steps of FIG. 7 are applied also to directory entries.

In an embodiment, the control unit 20 is adapted to perform the verification only by checking whether both file systems data share one file set descriptor FSD.

According to another embodiment, the control unit 20 is capable of comparing versions of MRW and CE file systems, for example to check whether both file systems are UDF file systems. This is used to check whether the first file system address references format is the same as the second file system address references format.

In a further embodiment, the control unit 20 is adapted to check whether the MRW file system partition and the CE file system partition start at the same point. This facilitates checking whether the first file system reference point is the same as the second file system reference point.

Advantageously, in another embodiment of the device, the control unit 20 is adapted to compare dates and times of modification of MRW and CE file systems data in order to decide whether it is necessary to update the CE file system data.

Information related to both file systems address references formats and both file systems reference points can be represented by a bit flag. For example, a value of the bit flag can correspond to a condition where the first file system address references format is the same as the second file system address references format and the first file system reference point is the same as the second file system reference point.

In an embodiment, the control unit 20 is adapted to check the bit flag in order to find out if it is necessary to record separate set of file entries for the second file system.

The same or an additional bit flag can be used to represent information related to a condition that both file systems data share one file set descriptor. Consequently, in another embodiment, the control unit 20 is capable of checking relevant bit flag in order to find out if it is necessary to record separate set of directory entries for the second file system.

Usage of bit flag(s) simplifies the verification performed by the control unit 20.

Advantageously, in another embodiment, the control unit 20 is adapted to read the bit flag(s) from the bridge medium.

In an embodiment, the control unit 20 is capable of initializing the bridge medium. As a part of this initialization AVDP, MVDS, VRS and FSD of both file systems data (in this case UDF file systems data) are recorded on the medium. This part of the initialization can be performed as one action (recording the MRW and CE file systems data) or two actions separated in time, where first, the MRW file system data are recorded and later, the CE file system data are recorded, e.g. as a result of a “make convergence” request. The control unit 20 is adapted to set the same starting point (location) for partitions defined by partition descriptors MRW PD and CE PD. For different versions of file systems MRW FS and CE FS, care should be taken that the first file system address references format is the same as the second file system address references format. Thus, the bridge medium is obtained on which it is enough to record only one set of file entries shared by both file systems data, as shown in FIG. 5.

In an embodiment of the method according to the invention, the initialization is performed as a step INIT 101, as shown in FIG. 7.

Further, in another embodiment, the control unit 20 is capable of recording the first file system LVD and the second file system LVD, both pointing to the same FSD. One FSD common for the first file system and the second file system is recorded on the medium. This means that not only file entries, but also directory entries are shared by both file systems data, as shown in FIG. 8.

For the MRW partition the defect management is applied. That means that data, which is logically part of the MRW partition can be physically located in the spare area Advantageously, in another embodiment, the control unit 20 is adapted to define the second file system partition comprising the spare area SA2, so the data remapped to SA2 can be addressed from within the CE partition.

In an embodiment, the control unit 20 is adapted to set-up the bit flag(s) representing one or more conditions described-above. For example, after or during the initialization the bit flag can be set, which value indicates that partitions defined by partition descriptors MRW PD and CE PD have the same starting point (location). The same or additional bit flag can be used to indicate that the first file system LVD and the second file system LVD point to the same FSD.

Advantageously, in another embodiment, the control unit 20 is adapted to record the bit flag(s) on the bridge medium.

In an embodiment of a computer data system comprising the host system and the device for recording digital information signals, the processing unit in the host system is adapted to control the control unit 20 to perform methods and functions as described in reference to embodiments of the device presented above.

A computer program product according to the invention is operative to cause the control unit 20 or the processing unit in the host system to perform methods and functions as described in reference to embodiments of the device presented above.

Whilst the invention has been described with reference to preferred embodiments thereof, it is to be understood that these are not limitative examples. Thus, various modifications may become apparent to those skilled in the art, without departing from the scope of the invention, as defined by the claims. Further, the invention lies in each and every novel feature or combination of features described above. Also, for the recording medium an optical disc has been described, but other media, such as a magneto-optical disc can be used. It is noted, that the invention may be implemented by means of a general purpose processor executing a computer program or by dedicated hardware or by a combination of both, and that in this document the word “comprising” does not exclude the presence of other elements or steps than those listed and the word “a” or “an” preceding an element does not exclude the presence of a plurality of such elements, that any reference signs do not limit the scope of the claims, that “means” may be represented by a single item or a plurality and that several “means” may be represented by the same item of hardware.

1. A device for recording digital information signals in addressable locations on a removable rewritable disc like recording medium, the digital information signals representing user data, first file system data and second file system data, each file system data comprising a corresponding set of file entries, the file entries comprising address references pointing to the user data according to a predefined format and defined relative to a reference point, the device comprising
recording means for recording the digital information signals on the medium;
reading means for reading recorded digital information signals recorded on the medium; and
control means for controlling recording the digital information signals, characterized in that
the control means are adapted to perform a verification in order to check whether the first file system address references format is the same as the second file system address references format and whether the first file system reference point is the same as the second file system reference point, and to record only one set of the file entries shared by both file systems data in case of positive result of the verification.

2. A device as claimed in claim 1, each file system data comprising a corresponding set of directory entries and a corresponding file set descriptor, the directory entries comprising address references pointing to the file entries according to the predefined format and defined relative to the reference point, the file set descriptor comprising information related to the set of directory entries and the set of file entries, the device characterized in that the control means are adapted to perform the verification comprising checking whether both file systems data share one file set descriptor, and to record only one set of the directory entries shared by both file systems data in case of positive result of the verification.

3. A device as claimed in claim 1, characterized in that the control means are adapted to perform the verification comprising comparing versions of both file systems.

4. A device as claimed in claim 1, characterized in that the control means are adapted to check a bit flag comprising information related to both file system address references formats and both file system reference points.

5. A device as claimed in claim 2, characterized in that the control means are adapted to check a bit flag comprising information related to the one file set descriptor.

6. A device as claimed in claim 4, characterized in that the control means are adapted to read the bit flag from the medium.

7. A device as claimed in claim 1, characterized in that the control means are adapted to perform an initialization comprising defining file system partitions on the medium such that the first file system partition and the second file system partition start at the same point being the first file system reference point and the second file system reference point, and such that the first file system address references format is the same as the second file system address references format.

8. A device as claimed in claim 2, each file system data comprising a corresponding volume descriptor pointing to the file set descriptor, characterized in that the control means are adapted to record the first file system volume descriptor and the second file system volume descriptor, both pointing to the one file set descriptor shared by both file systems data.

9. A device as claimed in claim 8, the medium comprising a spare area outside the user area comprising replacement areas for defect management, characterized in that the control means are adapted to define the second file system partition comprising the spare area.

10. A device as claimed in claim 4, characterized in that the control means are adapted to set-up the bit flag.

11. A device as claimed in claim 10, characterized in that the control means are adapted to record the bit flag on the medium.

12. A method of recording digital information signals in addressable locations on a removable disc like recording medium, the digital information signals representing user data, first file system data and second file system data, each file system data comprising a corresponding set of file entries, the file entries comprising address references pointing to the user data according to a predefined format and defined relative to a reference point, the method characterized by:
a verification step in order to check whether the first file system address references format is the same as the second file system address references format and whether the first file system reference point is the same as the second file system reference point; and
recording only one set of the file entries shared by both file systems data in case of positive result of the verification step.

13. A method as claimed in claim 12, each file system data comprising a corresponding set of directory entries and a corresponding file set descriptor, the directory entries comprising address references pointing to the file entries according to the predefined format and defined relative to the reference point, the file set descriptor comprising information related to the set of directory entries and the set of file entries, the method characterized by:
the verification step comprising checking whether both file systems data share one file set descriptor; and
recording only one set of the directory entries shared by both file systems data in case of positive result of the verification step.

14. A method as claimed in claim 12, characterized in that the verification step comprises comparing versions of both file systems.

15. A method as claimed in claim 12, characterized in that the verification step comprises checking a bit flag comprising information related to both file system address references formats and both file system reference points.

16. A method as claimed in claim 13, characterized in that the verification step comprises checking a bit flag comprising information related to the one file set descriptor.

17. A method as claimed in claim 15, characterized in that the bit flag is read from the medium.

18. A method as claimed in claim 12, characterized by an initialization step comprising defining file system partitions for recording the user data such that the first file system partition and the second file system partition start at the same point being the first file system reference point and the second file system reference point.

19. A method as claimed in claim 13, each file system data comprising a corresponding volume descriptor pointing to the file set descriptor, characterized by recording the first file system volume descriptor and the second file system volume descriptor, both pointing to the one file set descriptor shared by both file systems data.

20. A method as claimed in claim 19, the medium comprising a spare area outside the user area comprising replacement areas for defect management, characterized in that the second file system partition comprises the spare area.

21. A method as claimed in claim 15, characterized in that the initialization step comprises setting-up the bit flag.

22. A method as claimed in claim 21, characterized by recording the bit flag on the medium.

23. A computer data system comprising a computer connected to a device for recording digital information signals in addressable locations on a removable rewritable disc like recording medium, the digital information signals representing user data, first file system data and second file system data, each file system data comprising a corresponding set of file entries, the file entries comprising address references pointing to the user data according to a predefined format and defined relative to a reference point, the device comprising
input means connected to the computer for receiving the digital information signals;
recording means for recording the digital information signals on the medium;
reading means for reading recorded digital information signals recorded on the medium;
output means for outputting the read digital information signals to the computer; and
control means for controlling recording the digital information signals, characterized in that
the computer is adapted to control the control means of the device to perform the method according to claim 12.

24. A computer program product for recording digital information signals in addressable locations on a removable rewritable disc like recording medium, which program is operative to cause a processor to perform the method according to claim 12.
